(19) United States
(12) Patent Application Publication
(10) Pub. No.: US 2004/0084441 A1
(43) Pub. Date: May 6, 2004

(54) Resistance-heating element, and electric resistance furnace using the same

(75) Inventor: Masahiro Moriwaki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SHINAGAWA REFRACTORIES CO., LTD., Tokyo (JP)

(21) Appl. No.: 10/694,360

(22) Filed: Oct. 28, 2003

(30) Foreign Application Priority Data
Oct. 29, 2002 (JP) 2002-313729

(51) Int. Cl. H05B 3/10

(52) U.S. Cl. 219/552

(57) ABSTRACT

The invention provides a resistance-heating element comprising a cylindrical heating portion and a pair of terminals formed on an outer peripheral surface thereof, wherein a thermal shield for cutting off radiant heat from said heating portion is joined to each terminal at a spacing from the outer peripheral surface, another thermal shield differing in polarity is opposed to the one thermal shield with an insulating space located therebetween, a thermal shield portion is found at a site other than both ends of a straight line for joining an end of the outer peripheral surface of the thermal shield that faces the insulting space with an end of an inner peripheral surface thereof or an end of an inner peripheral surface of the another thermal shield of different polarity, and an opposite thermal shield exists on a straight line that joins the ends of the outer and inner peripheral surfaces of the thermal shield that faces at least one of the insulating spaces. The invention also provides an electric resistance furnace comprising that heating element located at its center and a preheating element located around the heating element.

### BACKGROUND OF THE INVENTION

The present invention relates generally to a high-temperature heating element that generates heat upon passage of electric current through it, and more particularly to a resistance-heating element that shows high heat resistance in an oxidizing atmosphere such as a zirconia-based heating element and an electric resistance furnace that uses the same and can be used at high temperatures.

Among various types of electric furnaces known so far in the art, an electric resistance furnace using a resistance-heating element has the features of being easy to handle and enabling in-furnace atmospheres to be easily set.

Especially for heating elements for electric resistance furnaces that can be heated to high temperatures in an oxidizing atmosphere such as one demanded for heat resistance testing where substances are heated to high temperatures, zirconia-based heating elements and lanthanum chromite-based heating elements are typically known. Among these, zirconia has the feature of being heated to temperatures of 700° C. to as high as 2,200° C.

Zirconia has a negative temperature coefficient of electric conductivity, and high electric resistance at low temperatures. For practical use of a zirconia-based heating element, it is inevitable to rely on preheating means for preheating the ziroconia-based heating element to a predetermined temperature.

On the other hand, once the zirconia-based heating element has worked to allow the electric resistance furnace to reach high temperature, such preheating means becomes no longer necessary. Instead, it is necessary to ensure means for disposal of radiant heat from the zirconia-based heating element and stable supply of electric current even to the zirconia-based heating element heated to high temperatures.

For instance, JP(A)1144490 discloses an electric resistance furnace using a hollow zirconia-based heating element as the zirconia-based heating element.

FIGS. 7(A) to 7(F) illustrate some exemplary embodiments of the conventional zirconia-based heating element as viewed from above.

As shown in FIG. 7(A) or 7(B), a zirconia-based heating element 1 includes at its center a hollow, rectangular column form of heating portion 2. On the outer peripheral surface of the heating portion there are provided terminals 3a and 3b symmetrical with respect to the axis of the heating element, and thermal shields 4a1, 4a2, 4b1 and 4b2 extend from the terminals 3a and 3b to cover the outer peripheral surface of the heating portion 2. An insulating space 6a is provided between the thermal shields 4a1 and 4a2 for prevention of short-circuits or arcs between them. An insulating space 6b is provided between the thermal shields 4b1 and 4b2 for the same purposes.

Referring to FIG. 7(C), there is provided a rectangular column form of heating portion 2 encircled with thermal shields 4a1, 4a2, 4b1 and 4b2, each having an inner and an outer peripheral surface that form together a cylindrical surface. Again, there are provided insulating spaces 6a and 6b.

Referring to FIG. 7(D), there is provided a cylindrical heating portion 2 encircled with thermal shields 4a1, 4a2, 4b1 and 4b2, each having an inner and an outer peripheral surface that form together a cylindrical surface.

Thus, the heating portion 2 is surrounded or encircled with the thermal shields 4a1, 4a2, 4b1 and 4b2 to cut off heat radiated from the heating portion, whereby efficient heating is achievable so that heat-insulating members located around the heating portion can be reduced or eliminated.

Referring FIG. 7(E), there is provided a rectangular column form of heating portion 2 surrounded with thermal shields 4a1, 4a2, 4b1 and 4b2, each having an inner and an outer peripheral surface that form together a cylindrical surface. Insulating spaces 6a and 6b are provided in the opposite portions of the thermal shields 4a1, 4a2 and 4b1 and 4b2 in such a way that the planes passing through the centers thereof do not intersect the center axis of the heating element. In FIG. 7(F), too, there is provided a cylindrical heating portion 2 as in FIG. 7 (E). With the arrangements shown in FIGS. 7(E) and 7(F), shielding of heat from the insulating spaces can more efficiently be achievable.

For the zirconia-based heating element, however, it is required to locate a preheating means comprising a preheating element or the like around it, because electric current must be passed through it after its electric resistance has been decreased by preheating. However, much radiant heat from the insulating spaces may often cause the temperature of the preheating means to become higher than the heat endurance temperature, resulting possibly in a degradation, break and durability reduction in the preheating element.

As the temperature of the terminals rises, the platinum or other leads attached thereto are liable to break. In addition, the temperature profile of the internal heating space often becomes uneven due to heat dissipated from it through the insulating spaces.

In particular, the plane of the preheating means upon projected from the inner peripheral surface of the insulting space onto the outer peripheral surface is so exposed to high temperature that a portion of the preheating element positioned thereat is often susceptible to premature degradation.

Additionally, the junctions of the thermal shields and the terminals, etc. are susceptible to cracking or other defects because the structure of where the thermal shields are formed at the terminals remains complicated.

A primary object of the invention is to provide a heating element having a high heat-endurance temperature such as a zirconia-based heating element, wherein heat radiated out of a center heating portion is so reduced that the amount of the necessary insulating members can be reduced with little or no thermal damage to a preheating means located around the heating element, and an electric resistance furnace using the same.

### BRIEF DESCRIPTION OF THE DRAWINGS

FIGS. 1(A) and 1(B) are illustrative in perspective of one embodiment of the resistance-heating element according to the invention.

FIGS. 2(A) and 2(B) are illustrative in perspective of one embodiment of the resistance-heating element according to the invention.

FIGS. 3(A) and 3(B) are illustrative of what relations the terminal has to the thermal shield.

FIGS. 4(A), 4(B) and 4(C) are plan views partly showing some configurations of the insulating space.

FIG. 5 is a longitudinal section illustrative of one embodiment of the electric resistance furnace according to the invention.

FIGS. 6(A) and 6(B) are illustrative of inventive comparative examples of the zirconia-based heating element.

FIGS. 7(A) to 7(F) are illustrative of some exemplary prior art zirconia-based heating element as viewed from above.

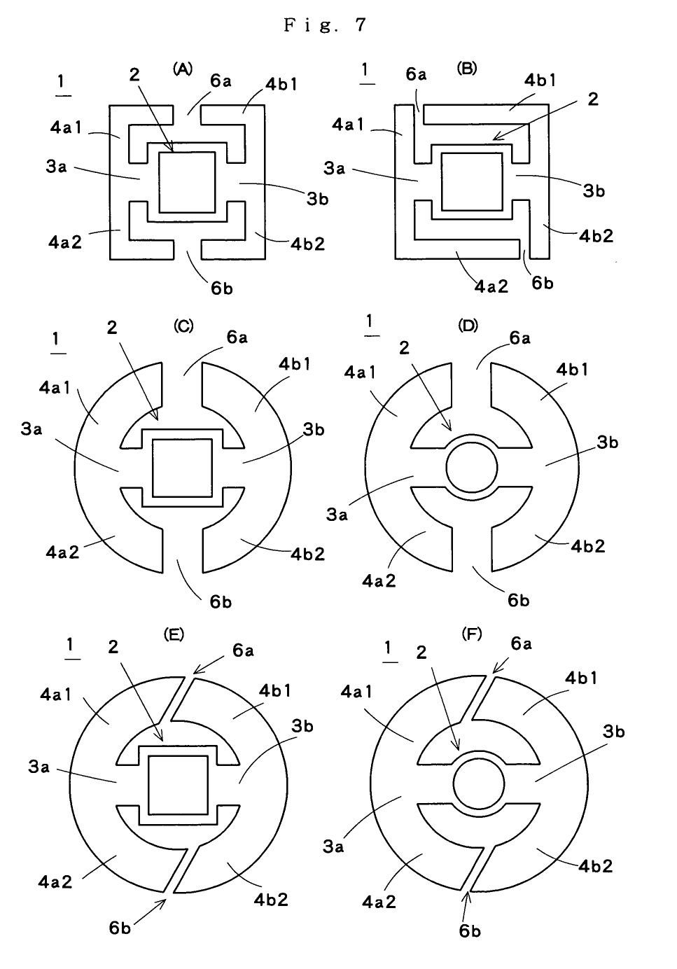

### SUMMARY OF THE INVENTION

The present invention provides a resistance-heating element comprising a cylindrical heating portion and a pair of terminals formed on an outer peripheral surface thereof, wherein:

a thermal shield for cutting off radiant heat frm said heating portion is joined to each terminal at a spacing from said outer peripheral surface,

another thermal shield differing in polarity is opposed to said one thermal shield with an insulating space located therebetween,

a thermal shield portion is found at a site other than both ends of a straight line for joining an end of the outer peripheral surface of said thermal shield that faces the insulting space with an end of an inner peripheral surface thereof or an end of an inner peripheral surface of said another thermal shield of different polarity, and

an opposite thermal shield exists on a straight line that joins the ends of the outer and inner peripheral surfaces of the thermal shield that faces at least one of the insulating spaces.

With such an arrangement, it is possible to prevent heat generated at the heating element from radiating directly to the outside of the thermal shields, because the insulating space between the thermal shields extending integrally form the heating element is not in any linear form. This in turn makes it possible to make efficient use of the heat generated at the heating element and the temperature profile more uniform. It is also possible to lessen thermal adverse influences on a preheating element located around the heating element and, hence, make the heat-endurance temperature of the preheating means used as the preheating element relatively low.

Preferably, the heating element is in a cylindrical form and the heat shields are provided with their outer peripheral surfaces located concentrically with respect to the heating portion.

The use of the cylindrical heating element ensures that the distance of the heating element to the center of the heating space is kept so constant that thermal distortion of the heating space by the heating element can be reduced.

Preferably, at least the juncture of the outer peripheral surface of the heating portion and each terminal is free from any planar portion.

There are large temperature differences among the center heating element, the terminals around it and the thermal shields extending from the terminals. However, the use of the planar portion-free juncture where the outer peripheral surface of the heating portion intersects each terminal ensures that such large temperature differences are reduced and there is little or no possibility of cracking or other failures of the heating element due to distortions caused by large temperature differences between the inner and outer peripheral surfaces of the terminals. This in turn ensures improved temperature-change durability.

Preferably, the juncture of the heating portion and each junction, which is largely affected by thermal distortions, is formed in a curved surface form rather than in a planar surface form.

The present invention also provides an electric resistance furnace including a center furnace body comprising an axially vertical, hollow heating element and holders located below and above said heating element wherein each holder comprises a heat-insulating member having an outside diameter defined by a maximum diameter of a terminal of said heating element and a preheating means located with a gap from a surface of said center furnace body wherein said preheating means comprises a preheating element formed on a cylindrical inner wall surface of a heat-insulating member, wherein:

a pair of terminals is formed on an outer peripheral surface of said hollow heating element,

a thermal shield for cutting off radiant heat from said heating portion is joined to each terminal at a spacing from said outer peripheral surface,

another thermal shield differing in polarity is opposed to said one thermal shield with an insulating space located therebetween,

a thermal shield portion is found at a site other than both ends of a straight line for joining an end of the outer peripheral surface of said thermal shield that faces the insulting space with an end of an inner peripheral surface thereof or an end of an inner peripheral surface of said another thermal shield of different polarity, and

an opposite thermal shield exists on a straight line that joins the ends of the outer and inner peripheral surfaces of the thermal shield that faces at least one of the insulating spaces.

Thus, heat radiated directly out of the center heating element through the insulating spaces between the thermal shields of the heating element is so reduced that thermal damage to the preheating element located as the preheating means can be reduced or eliminated, thereby providing an electric resistance furnace having improved reliability and durability.

Preferably, the electric resistance furnace comprises a plane-free, cylindrical heating element at junctures of the outer peripheral surface of the heating portion and the terminals.

Distortions applied to the heating element due to temperature differences occurring thereon can be reduced, thereby providing an electric resistance furnace comprising a heating element having much more improved durability.

Preferably, the heating element is a hollow zirconia-based heating element.

### DESCRIPTION OF THE PREFERRED EMBODIMENT

The present invention is now explained specifically with reference to the accompanying drawings.

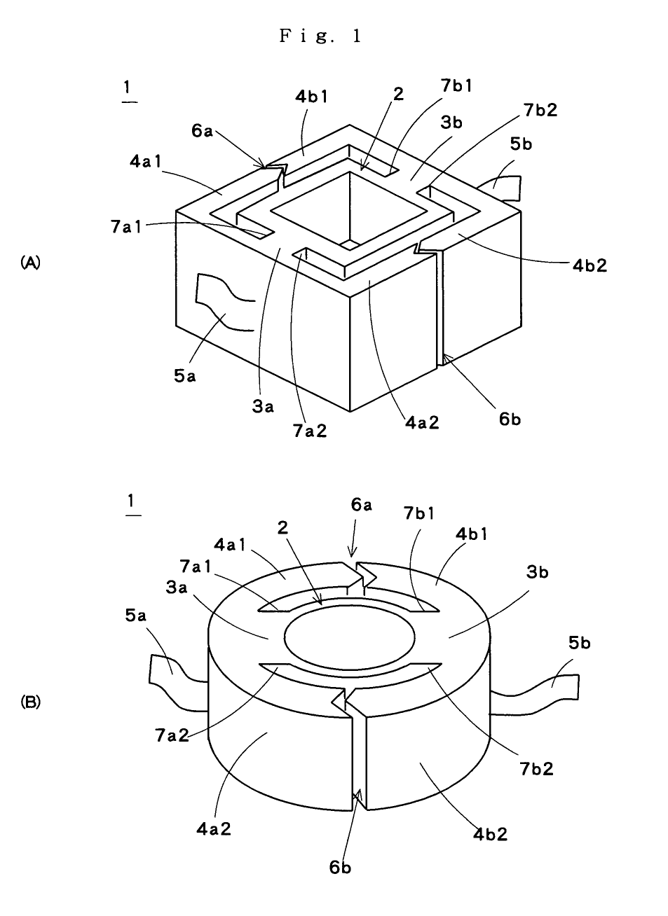

FIGS. 1(A) and 1(B) are illustrative of one embodiment of the resistance-heating element according to the invention.

Referring first to FIG. 1(A), a zirconia-based heating element 1 is provided at its center with a hollow, rectangular column form of heating portion 2. The heating portion 2 is provided on its outer perpheral surface with a pair of terminals 3a and 3b connected with electrically conductive connection leads 5a and 5b, respectively, for power supply. Thermal shields 4a1 and 4a2 for cutting off heat radiated out of the heating portion 2 extend integrally from the terminal 3a to encircle the outer peripheral surface of the heating portion 2, thereby cutting off the heat radiated out of the heating portion 2. Likewise, thermal shields 4b1 and 4b2 extend from the terminal 3b to encircle the heating portion 2.

An insulating space 6a is provided between the thermal shields 4a1 and 4b1 for prevention of short circuits or arcs between them. Likewise, an insulating space 6b is provided between the thermal shields 4a2 and 4b2 for prevention of short circuits or arcs between them.

It is noted that each of the insulating spaces 6a and 6b positioned between the thermal shields is not in a linear form; a thermal shield portion exists at a site other than both ends of a straight line for joining the end of the outer peripheral surface of one thermal shield that faces the insulting space with the end of the inner peripheral surface thereof or the end of the inner peripheral surface of another thermal shield of different polarity. Further, an opposite thermal shield exists on a straight line that joins the ends of the outer and inner peripheral surfaces of the thermal shield that faces at least one of the insulating spaces.

In the present disclosure, the term “end” means a line formed between the outer peripheral surface of the thermal shield and the insulating space, rather than a point. More specifically, the straight lines joining the ends mean not only four straight lines that join the ends of the upper surface of the heating element but also straight lines that join lines forming ends comprising straight lines or curved lines, implying not only those included in an axially vertical plane but also those intersecting the axially vertical plane.

Such an arrangement ensures that the inner peripheral surface of the thermal shield cannot be seen from the outer peripheral surface through the insulating space. The heat generated at the heating portion is cut off by the thermal shields and the heat radiated out of the heating portion is kept from passing directly through the non-linear insulating spaces, so that the primary radiant heat having increased thermal energy does not reach the outside of the heating element, preventing thermal damage to the preheating element located around the heating element.

Referring then to FIG. 1(B), a zirconia-based heating element 1 is provided at its center with a hollow, cylindrical heating portion 2. The heating portion 2 is provided on its outer peripheral surface with a pair of terminals 3a and 3b connected with electrically conductive connection leads 5a and 5b, respectively, for power supply. Thermal shields 4a1 and 4a2 for cutting off heat radiated out of the heating portion 2 extend integrally from the terminal 3a to encircle the outer peripheral surface of the heating portion 2, thereby cutting off the heat radiated out of the heating portion 2. Likewise, thermal shields 4b1 and 4b2 extend from the terminal 3b to encircle the heating portion 2.

An insulating space 6a is provided between the thermal shields 4a1 and 4b1 for prevention of short circuits or arcs between them. Likewise, an insulating space 6b is provided between the thermal shields 4a2 and 4b2 for prevention of short circuits or arcs between them.

It is noted that each of the insulating spaces 6a and 6b positioned between the thermal shields is not in a linear form; a thermal shield portion exists at a site other than both ends of a straight line for joining the end of the outer peripheral surface of one thermal shield that faces the insulting space with the end of the inner peripheral surface thereof or the end of the inner peripheral surface of another thermal shield of different polarity. Further, an opposite thermal shield exists on a straight line that joins the ends of the outer and inner peripheral surfaces of the thermal shield that faces at least one of the insulating spaces. Such an arrangement ensures that the inner peripheral surface of the thermal shield cannot be seen from the outer peripheral surface through the insulating space.

The heat generated at the heating portion is cut off by the thermal shields and the heat radiated out of the heating portion is kept from passing directly through the non-linear insulating spaces, so that the primary radiant heat having increased thermal energy does not reach the outside of the heating element, preventing thermal damage to the preheating element located around the heating element.

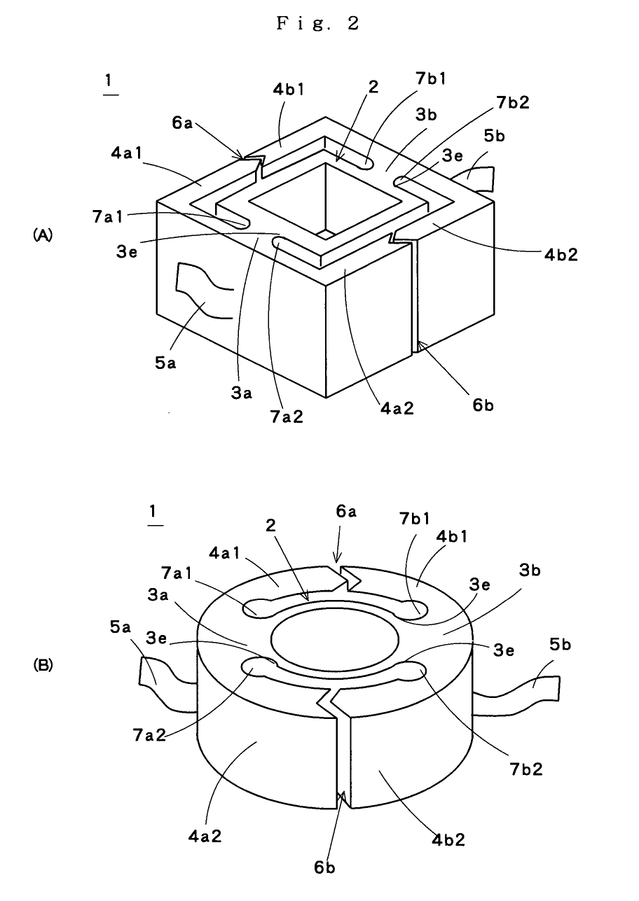

FIGS. 2(A) and 2(B) are illustrative in perspective of another embodiment of the resistance-heating element according to the invention. FIG. 2(A) shows a resistance-heating element having a rectangular column form of heating portion, and FIG. 2(B) shows a resistance-heating element having a cylindrical heating portion.

Referring first to FIG. 2(A), a zirconia-based heating element 1 is provided at its center with a hollow, rectangular column form of heating portion 2. The heating portion 2 is provided on its outer peripheral surface with a pair of terminals 3a and 3b connected with electrically conductive connection leads 5a and 5b, respectively, for power supply. Thermal shields 4a1 and 4a2 for cutting off heat radiated out of the heating portion 2 extend integrally from the terminal 3a to encircle the outer peripheral surface of the heating portion 2, thereby cutting off the heat radiated outof the heating portion 2. Likewise, thermal shields 4b1 and 4b2 extend from the terminal 3b to encircle the heating portion 2 with a spacing between them.

An insulating space 6a is provided between the thermal shields 4a1 and 4b1 for prevention of short circuits or arcs between them. Likewise, an insulating space 6b is provided between the thermal shields 4a2 and 4b2 for prevention of short circuits or arcs between them.

It is noted that each of the insulating spaces 6a and 6b positioned between the thermal shields is not in a linear form; a thermal shield portion exists at a site other than both ends of a straight line for joining the end of the outer peripheral surface of one thermal shield that faces the insulting space with the end of the inner peripheral surface thereof or the end of the inner peripheral surface of another thermal shield of different polarity. Further, an opposite thermal shield exists on a straight line that joins the ends of the outer and inner peripheral surfaces of the thermal shield that faces at least one of the insulating spaces. Such an arrangement ensures that the inner peripheral surface of the thermal shield cannot be seen from the outer peripheral surface through the insulating space.

Furthermore, junctions 7a1 and 7a2 that face the space defined by the terminal 3a, the outer surface of the heating portion 2 and the inner surfaces of the thermal shields as well as junctions 7b1 and 7b2 that face the space defined by the terminal 3b, the outer surface of the heating portion 2 and the inner surfaces of the thermal shields are each formed by a cylindrical surface rather than a plane. This ensures that thermal distortion applied to a juncture 3e of the outer surface of the heating portion and the terminal due to a temperature change between the interior of the heating portion and the junction remains decreased; it is possible to obtain a heating element having improved durability with respect to temperature changes.

Referring then FIG. 2(B), a zirconia-based heating element 1 is provided at its center with a hollow, cylindrical heating portion 2. The heating portion 2 is provided on its outer peripheral surface with a pair of terminals 3a and 3b connected with electrically conductive connection leads 5a and 5b, respectively, for power supply. Thermal shields 4a1 and 4a2 for cutting off heat radiated out of the heating portion 2 extend integrally from the terminal 3a to encircle the outer peripheral surface of the heating portion 2, thereby cutting off the heat radiated out of the heating portion 2. Likewise, thermal shields 4b1 and 4b2 extend from the terminal 3b to encircle the heating portion 2.

An insulating space 6a is provided between the thermal shields 4a1 and 4b1 for prevention of short circuits or arcs between them. Likewise, an insulating space 6b is provided between the thermal shields 4a2 and 4b2 for prevention of short circuits or arcs between them.

It is noted that each of the insulating spaces 6a and 6b positioned between the thermal shields is not in a linear form; a thermal shield portion exists at a site other than both ends of a straight line for joining the end of the outer peripheral surface of one thermal shield that faces the insulting space with the end of the inner peripheral surface thereof or the end of the inner peripheral surface of another thermal shield of different polarity. Further, an opposite thermal shield exists on a straight line that joins the ends of the outer and inner peripheral surfaces of the thermal shield that faces at least one of the insulating spaces. Such an arrangement ensures that the inner peripheral surface of the thermal shield cannot be seen from the outer peripheral surface through the insulating space.

Further, junctions 7a1 and 7a2 as well as junctions 7b1 and 7b2 at which the heating portion joins with the terminals in the spaces formed between the outer surface of the heating portion 2 and the thermal shields are each defined by a cylindrical or other curved surface rather than a plane. This ensures that thermal distortion applied to a juncture 3e of the outer surface of the heating portion and the terminals due to a temperature change between the interior of the heating portion and the junction remains decreased; it is possible to obtain a heating element having improved durability with respect to temperature changes.

In the invention, it is noted that the insulating space may be configured in any desired shape provided that the primary radiant heat from the heating portion is not directly emitted toward the outside, as typically explained below.

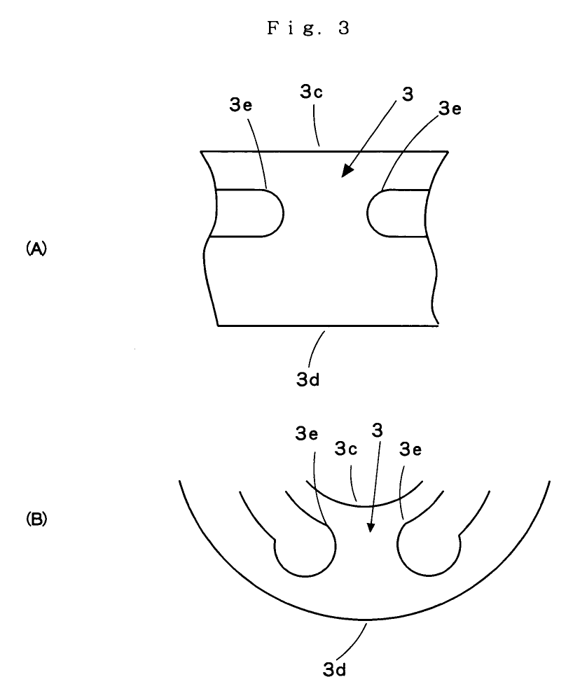

FIGS. 3(A) and 3(B) are illustrative of what relations the terminal has to the thermal shield.

FIG. 3(A) illustrates an arrangement comprising a rectangular column form of heating portion, and FIG. 3(B) illustrates an arrangement comprising a cylindrical heating portion.

A thick of a terminal 3 between an inner surface 3c and an outer surface 3d is larger than that of the rest of a zirconia-based heating element; between the inner surface 3c and the outer surface 3d there is a large temperature difference that applies a large thermal distortion to the terminal 3.

In particular, a large thermal distortion occurs at a juncture 3e at which the outer peripheral surface of a heating portion 2 intersects the terminal 3. Accordingly, it is preferable that the juncture 3e at which the outer peripheral surface of the heating portion 2 intersects the terminal 3 is defined by a curved surface, because the concentration of thermal distortion on the juncture 3e is avoided, resulting in prevention of cracking or other defects.

Not only the juncture of the outer peripheral surface of the heating portion 2 and the terminal but also a portion at which the thermal shield intersects the terminal be should preferably defined by a curved surface.

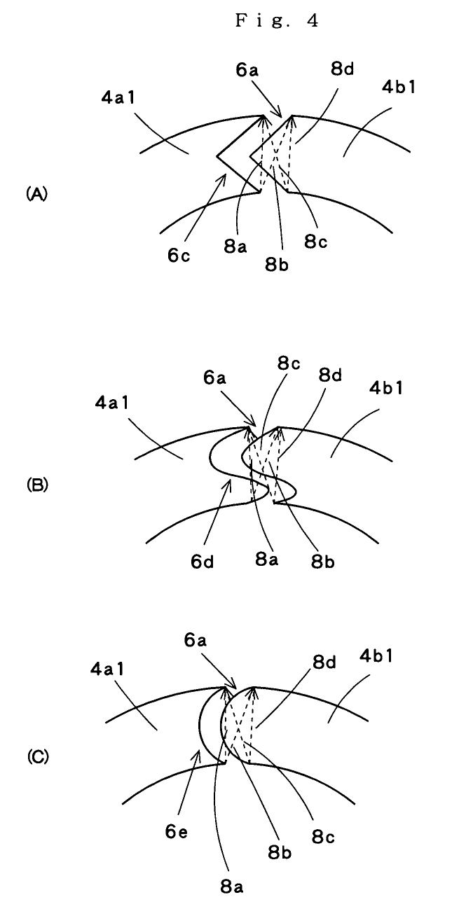

FIGS. 4(A), 4(B) and 4(C) are plan views partly showing some configurations of the insulating space.

Specifically, FIG. 4(A) is illustrative of the insulating space 6a depicted in FIGS. 1 and 2. This insulating space 6a is defined by two slants 6c. All straight lines 8a, 8b and 8c joining the points of intersection of the insulating space and the inner peripheral surfaces of the thermal shields with the points of intersection of the insulating space and the outer peripheral surfaces of the thermal shields cross the thermal shield so that the primary radiant heat from the heating portion is unlikely to reach the outside through the insulating space.

FIG. 4(B) illustrates another insulating space 6a that is defined by a wave-like curved surface 6d. All straight lines 8a, 8b, 8c and 8d joining the points of intersection of the insulating space and the inner peripheries of the thermal shields with the points of intersection of the insulating space and the outer peripheries of the thermal shields cross the thermal shield so that the primary radiant heat from the heating portion is unlikely to reach the outside through the insulating space.

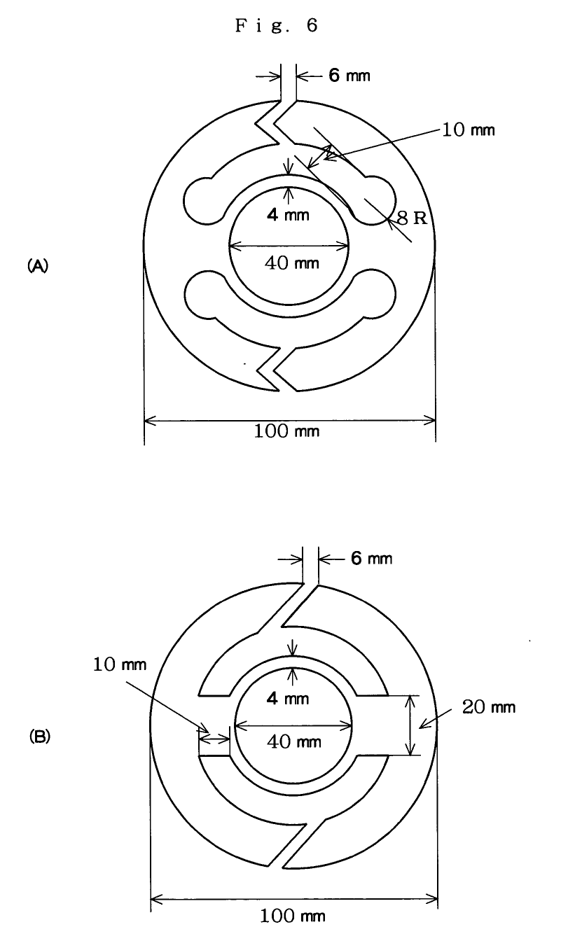

FIG. 6(C) is illustrative of yet another insulating space 6 that is defined by a curved surface 6e that is a part of a cylindrical surface. All straight lines 8a, 8b, 8c and 8d joining the points of intersection of the insulating space and the inner peripheral surfaces of the thermal shields with the points of intersection of the insulating space and the outer peripheral surfaces of the thermal shields cross the thermal shield so that the primary radiant heat from the heating portion is unlikely to reach the outside through the insulating space.

FIGS. 4(A), 4(B) and 4(C) are plan views, and so the portions of intersection of the insulating space and the inner or outer peripheral surface of the thermal shield is described as being the point of intersection. However, the heating element of the invention is a solid body, and so the end referred to herein is understood to mean a line that joins the points of intersection as the heating element is cut on an axially vertical plane.

Thus, the heat radiated out of the heating portion cannot pass directly through the non-linear insulating space; the primary radiant heat having large thermal energy is unlikely to reach around the heating portion, thereby preventing any thermal damage to the preheating element positioned around the heating portion.

The size of the insulating space should preferably be in the range of 2 mm to 10 mm although varying with the size of the heating element.

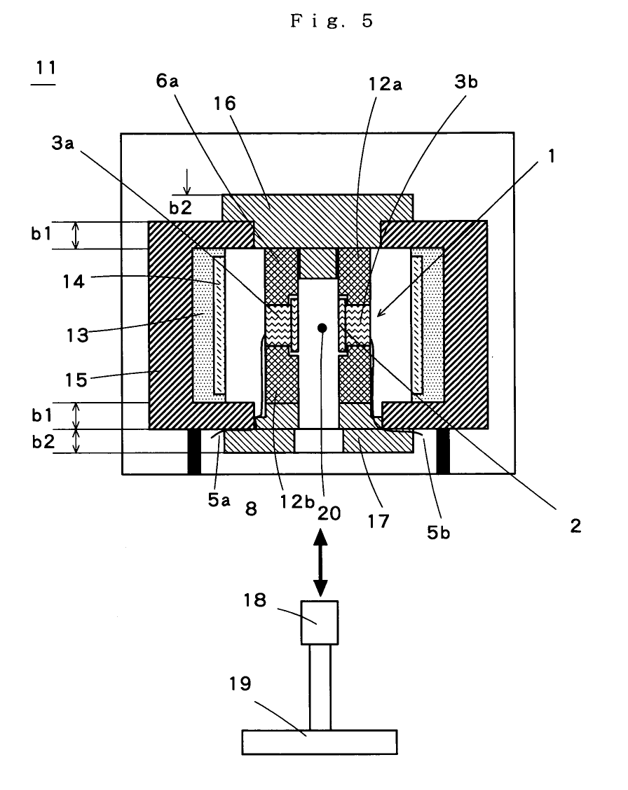

FIG. 5 is a longitudinal section illustrative of one embodiment of the electric resistance furnace according to the invention.

An electric resistance furnace 11 comprises a truncate, cylindrical zirconia-based heating element 1 formed of a hollow zirconia-based refractory material. At the center of the zirconia-based heating element 1, there is provided a cylindrical heating portion 2 joined to columnar terminals 3a and 3b. Platinum or other electrically conductive connection leads 5a and 5b are connected to the terminals 3a and 3b for connection to a heating power source circuit.

Above and below the zirconia-based heating element 1, there are provided zirconia-based refractory members 12a and 12b. Spaced away from the zirconia-based heating element 1, there is concentrically provided a cylindrical heat-insulating refractory member 13 having on its inside surface a preheating element 14 formed of a heat-resistant alloy. The heat-insulating member may be spirally wound on the inside surface of the cylindrical member or, alternatively, it may be a rod or sheet member formed thereon. Further, an outermost heat-insulating member 15 is provided on the outside, upper surface and bottom surface of an assembly comprising these components.

In the electric resistance furnace shown in FIG. 5, the hollow zirconia-based heating element is provided on its outside surface with columnar terminals 3a and 3b. Further, the zirconia-based heating element is provided with thermal shields that are integral parts of the terminals. A heat-insulating space provided between the thermal shields differing in polarity is structurally designed such that the primary radiant heat from the zirconia-based heating element does not reach the outside. This ensures that the primary radiant heat from the zirconia-based heating element is not directly radiated to the preheating element. Thus, if the preheating element is spaced away from the zirocnia-based heating element at a given spacing, it is then possible to prevent any thermal damage to the preheating element and, hence, use the preheating element over an extended period of time.

An upper heat-insulating member 16 is provided at a site of the upper surface of the electric resistance furnace 11, which is found on the center axis side of the furnace 11 with respect to an area of projection of the preheating element 14. Likewise, a lower heat-insulating member 17 is provided at a site of the bottom surface of the electric resistance furnace 11, which is found on the center axis side with respect to the area of projection of the preheating element 14.

At the lower portion of the electric resistance furnace 11, there is provided an elevator means 19 for introducing the sample 18 to be heated in a cylindrical internal space in the zirconia-based heating element, so that the sample 18 can be admitted into a heating space 20 heated to high temperature.

Upon startup of the electric resistance furnace 11 of the invention, electric current is passed through the preheating element 14 to make the electric conductivity of the zirconia-based heating element high enough for the full passage of electric current, following which the passage of electric current through the preheating element 14 is switched over to the passage of electric current through the zirconia-based heating element 1 so that the heating space can be brought by the passage of electric current through the zirconia-based heating element up to a predetermined temperature.

In the electric resistance furnace 1 of the invention, the upper heat-insulating member 16 and the lower heat-insulating member 17 are not located outside of the area of projection of the preheating element 14, so that even when the zirconia-based heating element is heated to high temperature by the passage of current, dissipation of heat out of the electric resistance furnace can occur properly, with the result that the increase in the temperature of the preheating element is less large. Thus, the preheating element formed of commonly available ferrite-based resistance alloy such as Kanthal wires can be well used, and so it is unnecessary to use any cooling means using water or other heat medium with the electric resistance furnace.

According to the present invention, a gap of preferably 10 mm to 100 mm and more preferably 20 mm to 60 mm should be provided between the zirconia-based heating element and the preheating element.

A gap of less than 10 mm is not preferred because of increased radiation heat to the preheating element. A gap of greater than 100 mm is again not preferred because of a drop of the efficiency of heating by the preheating element.

The zirconia-based heating element used herein could be prepared using stabilized zirconia to which yttria, calcia, magnesia or the like is added as a stabilizer. For the stabilized zirconia, it is preferable to use yttria-stabilized zirconia wherein the stabilizer is added in an amount of 5 to 20% by mass relative to the stabilized zirconia.

Although fired zirconia powders may be used for zirconia, it is preferable to make use of a mixture of zirconia powders with zirconia fibers because of increased strength with respect to thermal stress. The zirconia fibers used should preferably have a diameter of 0.1 μm to 20 μm and a length of 0.1 mm to 50 mm, and the zirconia powders should preferably have a particle diameter of 0.1 μm to 1,000 μm.

A mixture of zirconia powders with yttria-zirconia fibers, bonded together by methyl cellulose or other binder, may be molded or otherwise formed, and fired. In addition to the zircoia powders and zirconia fibers, a zirconia sol, an aqueous solution of zirconium salt or the like may be added.

Platinum leads or platinum-rhodium alloy leads used as current-carrying leads are joined to the terminals; however, it is preferable to fill zirconia mortar in the junctions of the current-carrying leads.

The present invention is now explained more specifically with reference to some inventive and comparative examples.

### Example 1

One hundred (100) parts by weight of yttria-stabilized zirconia powders and 100 parts by weight of yttria-stabilized zirconia fibers having a diameter of 5 μm blended together with 5 parts by weight of methyl cellulose and 70 parts by weight of water were press molded at a pressure of 100 MPa. After dried at 100° C. for 24 hours, the molded product was fired at 1,800° C. to prepare a heating element including V-shaped insulating spaces of 6 mm in width, as shown in FIG. 6(A). This heating element had a heating portion having an outside diameter of 48 mm, an inside diameter of 48 mm and a length of 40 mm with a terminal length of 25 mm.

This zirconia-based heating element was used to prepare an electric resistance furnace as shown in FIG. 5.

In FIG. 5, a cylindrical heat-insulating member of 240 mm in diameter, with a preheating element located on the inside surface of a cylinder having an inside diameter of 180 mm, was located with a 40-mm space from a distant end of a terminal of the zirconia-based heating element. Around the heat-insulating member, a rectangular column form of heat-insulating member of 325 mm in one side and 42 mm in thickness was located, and above and below the heat-insulating member heat-insulating members comprising alumina•silica fibers with b1=25 mm were provided. On the center axis side of an area of projection of the preheating element, uppermost and lowermost heat-insulating members of b2=25 mm in thickness were provided above and below the upper and lower heat-insulating members. Thus, an electric resistance furnace comprising a preheating furnace located around the zirconia-based heating element was prepared.

Around the furnace arrangement, there was provided a 1.2 mm-thick, soft steel punching metal having a number of openings of 4 mm in diameter.

Electric current was passed through the preheating element to allow the temperature of the zirconia-based heating element to reach 1,100° C., and the passage of electric current through the preheating element was thereafter switched over to the passage of electric current through the zirconia-based heating element to heat a heating space in the zirconia-based heating element up to the temperature of 2,000° C. Consequently, the temperature in the preheating furnace was found to reach a maximum of 1,300° C., which was lower than the heat-endurance temperature of the preheating element used.

It was also found that the electric resistance furnace of this example could stably withstand up to 150 cycle tests wherein a sample was heated at a heating rate of 5° C./min, held at 2,000° C. for 1 hour, and cooled at a cooling rate of 5° C./min.

### EXAMPLE 2

A zirconia-based heating element was prepared as in Example 1 with the exception that a heating portion having an outside diameter of 130 mm, an inside diameter of 120 mm and a length was used with a terminal length of 40 mm and CIP molding was performed at a pressure of 150 MPa. The heating element was housed inside of a preheating means comprising a cylindrical member having an inside diameter of 300 mm with a preheating element mounted on its inside surface to prepare an electric resistance furnace larger in size than that of Example 1. This electric resistance furnace could be run over an extended period of time as in Example 1.

### Comparative Example 1

An electric resistance furnace was prepared as in Example 1 with the exception that a heating element having linear insulating spaces of 6 mm in width as shown in FIG. 6(B) was used as the heating element, and subjected to cycle testing as in Example 1. At the 20th cycle the heating element of the preheating means broken.

As described above, the present invention provides a resistance-heating element wherein thermal shields that encircle the center heating portion are integrally formed with terminals connected to the heating portion and spaces defined by thermal shields having opposite polarities are formed in such a non-linear form that they cannot be seen through. It is thus possible to prevent the primary radiant heat from the heating portion from being directly emitted to the outside of the thermal shields to ensure sufficient thermal shielding without causing any thermal damage to the preheating element, etc. located around the heating element. This can in turn keep the preheating means from deterioration and makes it possible to use the preheating means over and over. An increase in the temperature of the terminals is so limited that the durability of platinum or other leads connected to the terminals can be improved. It is thus possible to manufacture an electric resistance furnace having much more improved heat resistance and durability. When the junctures of the outer peripheral surface of the heating portion and the terminals are free from any planar portion, it is possible to obtain a resistance-heating element less susceptible to thermal distortion and having much more improved durability.

What we claim is:

1. A resistance-heating element comprising a cylindrical heating portion and a pair of terminals formed on an outer peripheral surface thereof, wherein:
a thermal shield for cutting off radiant heat from said heating portion is joined to each terminal at a spacing from said outer peripheral surface,
another thermal shield differing in polarity is opposed to said one thermal shield with an insulating space located therebetween,
a thermal shield portion is found at a site other than both ends of a straight line for joining an end of the outer peripheral surface of said thermal shield that faces the insulting space with an end of an inner peripheral surface thereof or an end of an inner peripheral surface of said another thermal shield of different polarity, and
an opposite thermal shield exists on a straight line that joins the ends of the outer and inner peripheral surfaces of the thermal shield that faces at least one of the insulating spaces.

2. The resistance-heating element according to claim 1, wherein said heating element is in a cylindrical form and the heat shields are provided with their outer peripheral surfaces located concentrically with respect to

3. The resistance-heating element according to claim 1, wherein at least a juncture of the outer peripheral surface of the heating portion and each terminal is free from any planar portion.

4. The resistance-heating element according to claim 2, wherein at least a juncture of the outer peripheral surface of the heating portion and each terminal is free from any planar portion.

5. The resistance-heating element according to claim 1, wherein the heating element is a zirconia-based heating element.

6. The resistance-heating element according to claim 2, wherein the heating element is a zirconia-based heating element.

7. The resistance-heating element according to claim 3, wherein the heating element is a zirconia-based heating element.

8. The resistance-heating element according to claim 4, wherein the heating element is a zirconia-based

9. An electric resistance furnace including a center furnace body comprising an axially vertical, hollow heating element and holders located below and above said heating element wherein each holder comprises a heat-insulating member having an outside diameter defined by a maximum diameter of a terminal of said heating element and a preheating means located with a gap from a surface of said center furnace body wherein said preheating means comprises a preheating element formed on a cylindrical inner wall surface of a heat-insulating member, wherein:
a pair of terminals is formed on an outer peripheral surface of said hollow heating element,
a thermal shield for cutting off radiant heat from said heating portion is joined to each terminal at a spacing from said outer peripheral surface,
another thermal shield differing in polarity is opposed to said one thermal shield with an insulating space located therebetween,
a thermal shield portion is found at a site other than both ends of a straight line for joining an end of the outer peripheral surface of said thermal shield that faces the insulting space with an end of an inner peripheral surface thereof or an end of an inner peripheral surface of said another thermal shield of different polarity, and
an opposite thermal shield exists on a straight line that joins the ends of the outer and inner peripheral surfaces of the thermal shield that faces at least one of the insulating spaces.

10. The electric resistance furnace according to claim 9, wherein the heating element is a zirconia-based heating element.
